(19) United States
(12) Patent Application Publication
(10) Pub. No.: US 2014/0063494 A1
(43) Pub. Date: Mar. 6, 2014

(54) FLOW CELL

(71) Applicant: Shimadzu Corporation, Kyoto-shi (JP)

(72) Inventors: Takahide HATAHORI, Kyotanabe-city (JP); Naoji MORIYA, Nara-city (JP); Yukihisa WADA, Souraku-gun (JP); Yuji NAKAMA, Yamatokoriyama-city (JP)

(21) Appl. No.: 13/922,608

(22) Filed: Jun. 20, 2013

(30) Foreign Application Priority Data
Aug. 28, 2012 (JP) 2012-187360

(51) Int. Cl. G01N 21/05

(52) U.S. Cl. CPC G01N 21/05
USPC 356/246

(57) ABSTRACT

In a flow cell, where a light introducing member for introducing light for measurement into a linear capillary through which sample liquid flows is attached to one end of the capillary, and a light leading out member for leading light transmitted through the capillary while transmitting through the sample liquid flowing through the capillary out to the outside is attached to the other end, the light introducing member is a light waveguide inserted into the capillary, and the light leading out member is a window member attached to an opening at the other end of the capillary so the loss of the amount of light transmitted through the capillary can be suppressed, while it is possible for flow cells of which the optical path has a different length to be attached without causing a problem relating to the positional relationships in the optical system, such as an absorbance detector.

### TECHNICAL FIELD

The present invention relates to a flow cell for allowing a liquid to be measured to flow when, for example, the absorbance of the liquid is measured.

### BACKGROUND ART

In an absorbance detector used for a liquid chromatograph or the like, a container that is referred to as cell is irradiated with light for measurement from a light source in such a state that the container is filled in with a liquid to be measured (hereinafter referred to as sample liquid) or the liquid continuously flows through the container so that the intensity of light that has transmitted through the sample liquid is detected, and thus, the absorbance for each wavelength thereof is found. In order to measure a microscopic amount of sample liquid with a high level of sensitivity, it is necessary for the cross-section of the cell to be small and for the length of the optical path to be long. Therefore, a conventional flow cell that is referred to as light guide cell or the like has been put into practice, where a linear capillary is used as the cell in such a manner that a sample liquid flows through the inside of the capillary, and light enters through one end side of the capillary in the direction in which the capillary extends so as to be totally reflected from the outer or inner wall of the capillary and transmitted to the other end side of the capillary (see Non-Patent Document 1).

As a flow cell for allowing light to be totally reflected from the outer wall of the capillary and be transmitted, a flow cell where fused quartz is used for the capillary so that light is totally reflected from the interface between the quartz of the outer wall and air has been known (see Patent Document 1).

As a flow cell for allowing light to be totally reflected from the inner wall of the capillary and be transmitted, a flow cell where the capillary of which the inner wall is coated with Teflon (registered trademark) AF has been known (see Patent Document 2).

In addition, a two-end space coupling structure and a two-end light waveguide coupling structure have been put into practice as the structure for introducing light for measurement into the capillary and the structure for leading light that has transmitted through the sample liquid in the capillary out from the capillary.

The two-end space coupling structure is a structure where a light introducing window member and a light leading out window member are provided in the two end portions of the capillary so that, via these window members, light from a light source enters directly through the space into the capillary and light that has transmitted through the sample liquid is directly emitted from the capillary into the space (see Patent Document 3).

Meanwhile, the two-end light waveguide coupling structure is a structure where light waveguides, such as optical fibers, are respectively inserted into the two end portions of the capillary so that light from a light source is introduced into the capillary via the light waveguide on one end side and the light that has transmitted through the sample liquid is lead out of the capillary via the light waveguide on the other end side (see Patent Document 4).

### PRIOR ART DOCUMENTS

### Patent Documents

Patent Document 1: U.S. Pat. No. 4,477,186
Patent Document 2: Japanese Translation of International Unexamined Patent Publication 2002-536673
Patent Document 3: Japanese Unexamined Patent Publication H11 (1999)-173975
Patent Document 4: Japanese Patent No. 3657900

### Non-Patent Document

Non-Patent Document 1: “Distribution and Optical Path for Light from a Light Source in a Capillary Cell with a Long Optical Path Using Total Reflection from the Outer Wall of the Cell” (Kinichi Sumida et al., Nippon Kagaku Kaishi, 1989(2), pp. 233-236, 1989)

### SUMMARY OF THE INVENTION

### Problem to be Solved by the Invention

The absorbance of a sample liquid is proportional to the concentration of the sample liquid and the length of the optical path (Lambert-Beer Law). In the above-described flow cells using a capillary, it is possible to measure a sample liquid having a low concentration with a high level of sensitivity if a cell with a long optical path is used. However, the long optical path makes the absorbance excessive, and thus makes the amount of light low when a sample liquid having a high concentration is measured, and as a result, measurement becomes difficult. Therefore, cells of which the optical path has a different length are used for a sample liquid having a different concentration so that the precision for detecting the absorbance can be increased, and as a result, the precision for analysis can be increased when applied to a liquid chromatograph.

When cells of which the optical path has a different length are connected to the same optical system, however, in the two-end space coupling structure from among the above-described cell structures, either or both the light inlet and the light outlet are located in different locations for each cell, and thus, they end up not being in the optimal locations along the optical axis.

Meanwhile, in the two-end light waveguide coupling, the whole length of the capillary or the amount of insertion of the light waveguides into the two ends of the capillary can be changed so that the length of the optical path can be changed in a state where the locations of the light inlet and the light outlet stay the same. However, the use of light waveguides causes a loss in the amount of light, and therefore, such a problem arises that the amount of light is low as compared to the above-described two-end space coupling structure.

The present invention is provided in light of the above-described circumstances, and an object thereof is to provide a flow cell that can be attached to the same optical system without lowering the amount of light as compared to the prior art and without causing a problem relating to the positional relationship along the optical axis even when the length of the optical path varies.

### Means for Solving Problem

In order to achieve the above-described object, the flow cell according to the present invention is a flow cell having; a linear capillary through which a sample liquid flows; a light introducing member for introducing light for measurement into the capillary, the light introducing member being attached to one end of the capillary; and a light leading out member for leading light that has transmitted through the capillary while transmitting through the sample liquid flowing through the capillary out to the outside, the light leading out member being attached to the other end of the capillary, and is characterized in that the above-described light introducing member is a light waveguide inserted into the capillary through an opening at one end of the above-described capillary, and the above-described light leading out member is a window member attached to an opening at the other end of the capillary (Claim 1).

Here, it is preferable in the present invention to adopt a structure where the above-described light waveguide is an optical fiber without an outer coating or a quartz cylinder (Claim 2).

In addition, it is also possible in the present invention to adopt a structure where a quart convex lens is provided in the end portion of the above-described light waveguide on the light source side (Claim 3).

The object of the present invention can be achieved by making only the structure on the light introducing side from among the structures of the capillary on the light introducing side and on the light leading out side a structure where a light waveguide is inserted into the capillary (light waveguide coupling) and by making the structure on the light leading out side a structure using a window member (space coupling).

That is to say, it is not necessary to insert a light waveguide into the capillary at the two ends in order to make the optical path have a different length, but instead it is sufficient to provide a structure where a light waveguide is inserted at either end, and thus, loss in the amount of light can be suppressed as compared to the conventional structure with two-end light waveguide coupling. In addition, the structure where a light waveguide is inserted on the light introducing side is more appropriate than the structure where a light waveguide is inserted on the light leading out side in terms of the lower loss in the amount of light as described below, and thus, this structure is adopted in the present invention.

The structure where a light waveguide is inserted into the capillary in order to introduce light or emit light is more efficient than the structure where an end of a light waveguide faces the capillary from the outside so that light is introduced or emitted through a window made of quartz which seals the capillary at the end because the former structure does not have a risk of loss being caused in the coupling between the light waveguide and the window. However, a loss of light is caused on the light leading out side by the difference between the cross-section of the capillary for light transmission and the cross-section of the light waveguide because of the fact that the light that has transmitted through the capillary is picked up by the light waveguide inserted into the capillary. That is to say, the cross-section of the capillary for light transmission is the cross-section inside the capillary including the outer wall because the capillary transmits light by making the light be totally reflected from the interface between the outer wall and air, while the light waveguide is inserted into the capillary inside the inner wall, and therefore, the cross-section of the light waveguide for light transmission is smaller than that of the capillary, and the amount of light that is picked up is smaller by the difference. Here, no such loss occurs on the light introducing side.

Therefore, in the invention according to Claim 1, it is possible to attach a flow cell of which length of the optical path varies to the same optical system on the detector side, for example, on the absorbance detector side, without affecting the positional relationship along the optical axis while suppressing the loss in the amount of light.

In addition, the amount of light can be increased in the light waveguide used on the light introducing side of the capillary according to the present invention by using a light waveguide in which light is totally reflected from the interface between the outer wall and air, that is to say, by using an optical fiber without an outer coating or a quartz cylinder (rod) as in the invention according to Claim 2. Though the NA (numerical aperture) for possible transmission through a conventional optical fiber with a coating can be determined by the difference in the refractive index between the core and the clad, materials having a low refractive index are limited, and thus, the NA is limited. Total reflection from the interface between the outer wall and air can provide a larger difference in the refractive index than in an optical fiber having a core and a clad so that light with a higher NA can be transmitted, making it possible to increase the amount of light.

In addition, a quartz convex lens can be provided in the end portion of the light waveguide on the light source side as in the invention according to Claim 3 so that the effect of condensing light from the light source can be increased and the amount of light that is introduced into the capillary can be increased.

### Effects of the Invention

According to the present invention, it is possible to attach a flow cell of which the length of the optical path varies to the same detection optical system provided in the absorbance detector in a liquid chromatograph, for example, without affecting the positional relationship along the optical axis, while increasing the amount of light as compared to a conventional flow cell having a two-end light waveguide coupling structure, and it is also possible to precisely detect the absorbance of a sample liquid of which the concentration ranges from low to high by selectively attaching an appropriate flow cell, and as a result, a precise analysis becomes possible.

### BRIEF DESCRIPTION OF THE DRAWINGS

FIG. 1(A) is a schematic cross-sectional diagram showing an example having a long optical path, and FIG. 1(B) is a schematic cross-sectional diagram showing an example having a short optical path in an embodiment according to the present invention;

FIG. 2 is a block diagram showing an example of the entire structure of the optical system in the absorbance detector used for the present invention;

FIG. 3 is a graph showing the results of measurement of the amount of transmitted light for each incident NA for comparison between the present invention and a comparative example; and

FIG. 4 is a graph showing the results of measurement of the total amount of transmitted light for a similar comparison to that in FIG. 3 between the present invention and a comparative example.

### PREFERRED EMBODIMENTS OF THE INVENTION

In the following, the preferred embodiments according to the present invention are described in reference to the drawings.

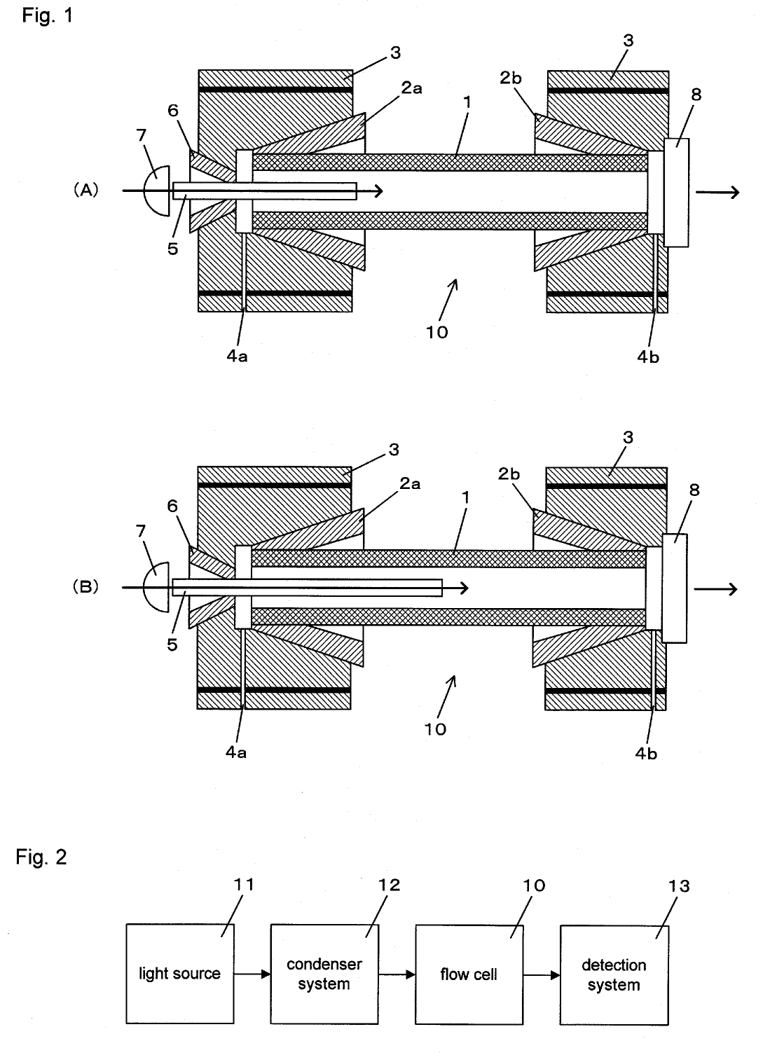

FIGS. 1(A) and 1(B) are schematic cross-sectional diagrams in an embodiment according to the present invention where FIG. 1(A) shows an example having a long optical path and FIG. 1(B) shows an example having a short optical path.

The two ends of a capillary 1 made of fused quartz are attached liquid tight to a cell holder 3 by means of holding members 2a, 2b made of a resin, such as ferrules. A liquid introducing path 4a connected to one end of the capillary 1 and a liquid leading out path 4b connected to the other end of the capillary 1 are formed in the cell holder 3 so that a sample liquid is introduced into the capillary 1 through the liquid introducing path 4a, and the sample liquid that has flown through the capillary 1 is discharged to the outside through the liquid leading out path 4b. Though the direction in which light enters and the direction in which the liquid flows are the same in FIG. 1, these directions may be opposite. That is to say, the light introducing path may be on the 4b side and the light leading out path may be on the 4a side.

A light waveguide 5 is inserted into the capillary 1 through one end. An optical fiber without an outer coating or a quartz cylinder (rod) is used for this light waveguide 5, which is held by the cell holder 3 via a holding member 6. A quartz convex lens 7 is provided in an end portion of this light waveguide 5 on the outside of the capillary 1, that is to say, in the portion through which light enters into the light waveguide 5. Here, the diameter of the light waveguide 5 is approximately 0.1 mm to 1.0 mm.

Meanwhile, a window member 8 is attached to the capillary 1 at the other end. The form of this window member 8 is not particularly limited, but the window member 8 can be formed as a flat plate or as a lens, for example.

The difference between the flow cell having a long optical path in FIG. 1(A) and the flow cell having a short optical path in FIG. 1(B) lies in the amount by which the light waveguide 5 is inserted into the capillary 1 (in other words, the length of the light waveguide 5). The other components, such as the capillary 1 and the cell holder 3, to which the same symbol is attached in FIGS. 1(A) and 1(B) are the same components having exactly the same form and the same size, and the size between the quartz convex lens 7 and the window member 8 is exactly the same in the assembled state.

As for other techniques for changing the length of the optical path, a technique for changing the length of the capillary while maintaining the amount by which the light waveguide is inserted into the capillary at a constant, or a technique for changing both the length of the capillary and the amount by which the light waveguide is inserted into the capillary may be adopted, and these techniques can also realize variations in the length of the optical path.

The above-described embodiments according to the present invention may be used for an absorbance detector in a liquid chromatograph, for example. That is to say, the liquid eluded from the column of a liquid chromatograph is made to flow through the capillary 1 as a sample liquid, while the sample liquid in the capillary 1 is irradiated with light through a light waveguide 5 so that the transmitted light can be detected by the detection system outside the capillary 1 through a window member 8. The block diagram in FIG. 2 shows an example of the structure of such an optical system. In FIG. 2, the flow cell in FIG. 1 is denoted by 10. Light from a light source 11 is condensed by a condenser system 12 so as to be introduced into the capillary 1 through the light waveguide 5 via a quartz convex lens 7 in the flow cell 10 in FIG. 1. Light that has transmitted through the sample liquid in the capillary 1 is guided to the detection system 13 via the window member 8. The detection system 13 is made of a wavelength dispersing element, for example, grating, and a photodiode array, and this detection system 13 detects the intensity of light that has transmitted through the sample liquid for each wavelength, and the absorbance for each wavelength by the sample liquid can be found from the detection results, and as a result, the components in the sample liquid eluded from the column can be analyzed.

The above-described flow cell 10 placed between the condenser system 12 and the detection system 13 cannot provide a precise measurement unless the length of the optical path is appropriately changed in accordance with the concentration of the sample liquid as described above. According to the present invention, as illustrated in FIGS. 1(A) and 1(B), measures can be taken by preparing flow cells of which the length of the optical path is different so that one with an appropriate length of the optical path can be selected in accordance with the concentration of the sample. At the time of selection, the flow cell can always be placed to have an optimal positional relationship relative to the optical axis of the optical system on the detector side because all the flow cells have the same appearance and the same size between the quartz convex lens 7 on the light entrance side and the window member 8 on the light exit side. In addition, the light waveguide 5 is provided only on the light introducing side, and therefore, the amount of light can be increased as compared to a conventional flow cell having the structure where a light waveguide is provided both on the light introducing side and on the light leading out side of the capillary.

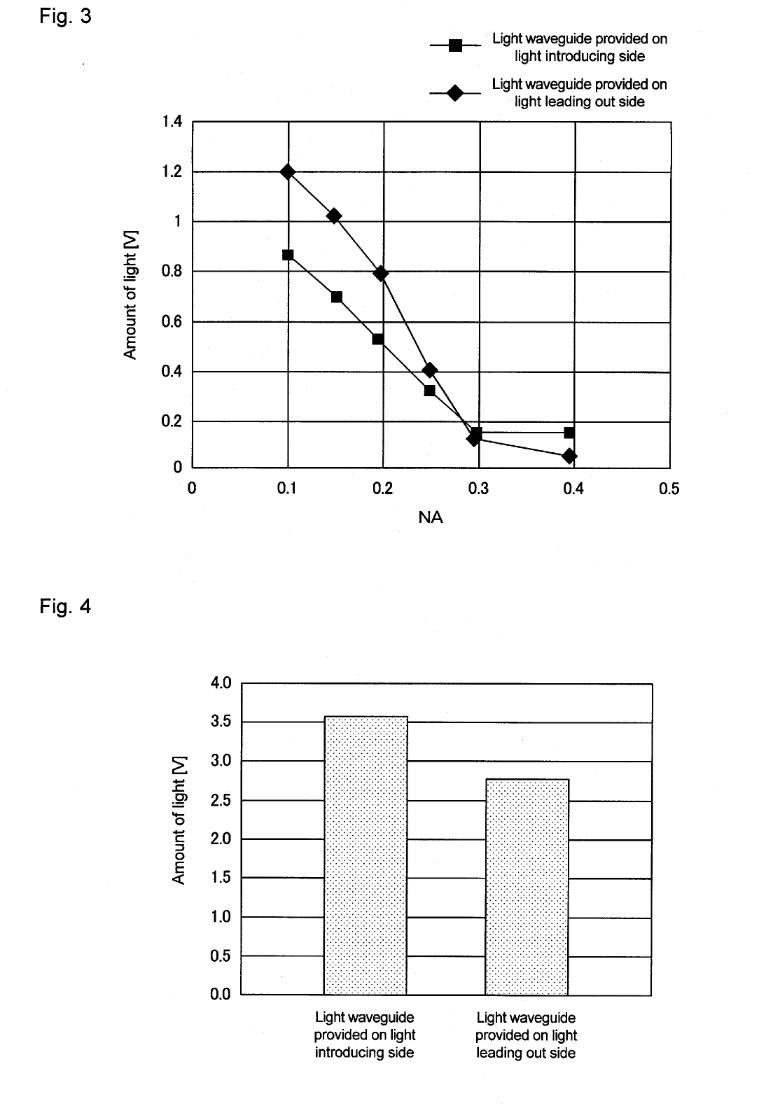

It is also confirmed that the amount of light greatly differs depending on the side, either the light introducing side or the light leading out side of the capillary, on which a light waveguide is provided, and according to the present invention, a light waveguide is provided on the light introducing side so that the amount of light is further increased. The graphs in FIGS. 3 and 4 show the verification results.

These graphs show the results of measurement of the amount of transmitted light for comparison between a case where a quartz rod is used for the light waveguide, and this light waveguide is provided on the light introducing side of the capillary, and a case where the light waveguide is provided on the light leading out side. The graph in FIG. 3 shows the results of the amount of transmitted light for each incident NA for comparison, and the graph in FIG. 4 shows the results of the total amount of transmitted light for comparison. As is clear from these graphs, the amount of transmitted light is large for each NA in the region for practical use, excluding light at a large incident angle of which the NA exceeds 0.3, by providing a light waveguide on the light introducing side of the capillary, and the total amount of light is approximately 1.35 times greater as compared to the case where the light waveguide is provided on the light leading out side, and thus, the usefulness of the structure of the present invention can be confirmed.

### EXPLANATION OF SYMBOLS

1 capillary
2a, 2b holding members
3 cell holder
4a liquid introducing path
4b liquid leading out path
5 light waveguide
6 holding member
7 quartz concave lens
8 window member
10 flow cell
11 light source
12 condenser system
13 detection system

1. A flow cell, comprising: a linear capillary through which a sample liquid flows; a light introducing member for introducing light for measurement into the capillary, the light introducing member being attached to one end of the capillary; and a light leading out member for leading light that has transmitted through the capillary while transmitting through the sample liquid flowing through the capillary out to the outside, the light leading out member being attached to the other end of the capillary, and being characterized in that
said light introducing member is a light waveguide inserted into the capillary through an opening at one end of said capillary, and said light leading out member is a window member attached to an opening at the other end of the capillary.

2. The flow cell according to claim 1, characterized in that said light waveguide is an optical fiber without an outer coating or a quartz cylinder.

3. The flow cell according to claim 1, characterized in that a quartz convex lens is provided in the end portion of said light waveguide on the light source side.

4. The flow cell according to claim 2, characterized in that a quartz convex lens is provided in the end portion of said light waveguide on the light source side.
